(19) United States
(12) Patent Application Publication
(10) Pub. No.: US 2006/0036726 A1
(43) Pub. Date: Feb. 16, 2006

(54) User interface for a distributed computing environment and method of using the same

(75) Inventors: Robert A. Fabbio, Austin, TX (US); Chris K. Immel, Austin, TX (US); David J. Wilson, Austin, TX (US); Jonathon D. Wilson, Austin, TX (US)

Correspondence Address: TOLER & LARSON & ABEL L.L.P., 5000 PLAZA ON THE LAKE STE 265, AUSTIN, TX, 78746, US

(73) Assignee: VIEO, Inc.

(21) Appl. No.: 10/889,569

(22) Filed: Jul. 12, 2004

(51) Int. Cl. G06F 15/173

(52) U.S. Cl. 709/224

(57) ABSTRACT

A user interface can present a unified view as a dynamic object-oriented metaphor for displaying information pertaining to any one or more applications and portions thereof (e.g., transaction types) and logical and physical components within a distributed computing environment, mapping between applications or portions thereof and information pertaining to those logical and physical components used by the applications or portions thereof, the health of the applications or portions thereof and logical and physical components, and the ability to control any or all of the applications or portions thereof and logical and physical components.

### CROSS-REFERENCE TO RELATED APPLICATIONS

This application is related to U.S. patent application Ser. No. 10/755,790 entitled “Methods and Systems for Estimating Usage of Components for Different Transaction Types” by Bishop et al. filed on Jan. 12, 2004, and U.S. patent application No. ______ entitled “Methods of Determining Usage of Components By Different Transaction Types and Data Processing System Readable Media for Carrying Out the Methods” by Bishop et al. filed on ______ (Docket No. VIEO1300), all of which are assigned to the current assignee hereof and incorporated herein by reference in their entireties.

### FIELD OF THE DISCLOSURE

The invention relates in general to user interfaces for generating displays, and more particularly to user interfaces for generating displays representing an instrument cluster for managing and controlling applications and portions thereof and methods of using the same.

### DESCRIPTION OF THE RELATED ART

Instruments, including gauges and controls, can be used to display information about physical components and logical components within a distributed computing environment. The physical components may include hardware, firmware, or software components, and the logical components can be constructs used by firmware or software, such as a buffer. A user may determine which instruments control physical or logical components, and which instruments monitor the physical or logical components. Typically, an instrument corresponds to one physical or logical component. The user or a programmer may configure software for a display, such as an instrument cluster. In one embodiment, the display is static in that the instruments displayed do not change unless a human intervenes. Such human intervention can include writing a script file that is executed to instruct a computer to change the instrument cluster configuration.

The instrumentation schema previously described works poorly for real world distributed computing environments. Simply put, real world distributed computing environments change at nearly any time or at any rate for any number of reasons. The prior schema with script files assumes the distributed computing environment has a static set of physical or logical components or in a worst case, changes on a relatively infrequent basis. Clearly, the assumption regarding the static set of physical and logical components within the distributed computing environment is incorrect. Physical and logical components may be provisioned and de-provisioned (e.g., added and removed) at various times and frequencies. For example, a web services tier may include 137 servers at one time. A little later, specific servers are added and removed, so at a second time, the tier may include 150 servers. Each time a physical or logical component is provisioned or de-provisioned, the instrumentation would need to be reconfigured to reflect the current set of physical and logical components. With physical and logical components coming and going, reconfiguration can become infeasible due to the number of components and rate of changes in the distributed computing environment and the cost associated with manually reconfiguring the instruments every time a change occurs.

### SUMMARY

A user interface can present a unified view as a dynamic object-oriented metaphor for displaying information pertaining to any one or more applications and portions thereof (e.g., transaction types) and logical and physical components within a distributed computing environment, mapping between applications or portions thereof and information pertaining to those logical and physical components used by the applications or portions thereof, the health of the applications or portions thereof and logical and physical components, and the ability to control any or all of the applications or portions thereof and logical and physical components.

The user interface can generate displays, wherein each display effectively presents an overview of a portion of a distributed computing environment, such as a specific application or portion thereof (e.g., a transaction type), a specific logical or physical component, a specific network service, or the like. The display can include performance indicators for that portion of the distributed computer environment (e.g., application, tier, component, service, etc.) being examined by coalescing readings from physical and logical instruments to provide a simple, understandable display. The display can include an optional navigation section to allow user to more quickly locate the part of the distributed computing environment that the user wants to see. Other information displayed may depend on the particular portion of the distributed computing environment being examined. The other information may include (1) representations of a set of components within the distributed computing environment, wherein the first set of components significantly affect any one or more of the performance indicators, (2) one or more controls that significantly affect one or more of the performance indicators, (3) a representation of a component that lies within or uses the portion of the distributed computing environment being examined, (4) one or more applications that use the portion of the distributed computing environment being examined, or (5) any combination of (1) to (4).

The displays generated by the user interface can provide information that changes dynamically and in real time or near real time to reflect changes in the distributed computing environment as the distributed computing environment adapts to applications running within it. Therefore, with a single display, users can easily see relevant information regarding a specific application or portion thereof, a specific logical or physical component, or a specific network service in real time or near real time. A user is able to examine or even explore the capabilities of the physical or logical components within the distributed computing environment and to give the user the ability to drill down to whatever level of detail that the user desires. The single display can effectively provide an easily understood picture of the dynamic infrastructure used to support an application or a portion thereof (e.g. a transaction type) that is dynamically updated.

In one embodiment, the user interface does not require any configuration on the part of the user. In another embodiment, the user interface can allow users to customize the displays to create their own personal views. Therefore, the user interface has the flexibility to provide a default display or a personally customized display. In another embodiment, the performance indicators for any or all parts of the distributed computing environment may be static, or alternatively, may be changed by a user at nearly any time.

The foregoing general description and the following detailed description are only to illustrate and are not restrictive of the invention.

### BRIEF DESCRIPTION OF THE DRAWINGS

The present invention is illustrated by way of example and not limitation in the accompanying figures, in which the same reference number indicates similar elements in the different figures.

FIG. 1 includes an illustration of a hardware configuration of a distributed computing environment and an appliance for managing and controlling the distributed computing environment.

FIG. 2 includes an illustration of a hardware configuration of the application management and control appliance in FIG. 1.

FIG. 3 includes an illustration of a display for a distributed computing management.

FIG. 4 includes an illustration of a display for an application running within distributed computing environment.

FIG. 5 includes a flow diagram illustrating a method of using the user interface to display components that significantly affect the run-time behavior of an application running within a distributed computing environment.

FIGS. 6-8 include illustrations of displays for other parts of a distributed computing environment.

FIGS. 9-13 include illustrations of displays related to creating, editing, and using personal views.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A user interface can present a unified view as a dynamic object-oriented metaphor for displaying information pertaining to any one or more applications and portions thereof (e.g., transaction types) and logical and physical components within a distributed computing environment, mapping between applications or portions thereof and information pertaining to those logical and physical components used by the applications or portions thereof, the health of the applications or portions thereof and logical and physical components, and the ability to control any or all of the applications or portions thereof and logical and physical components.

The user interface can generate displays, wherein each display effectively presents an overview of a portion of a distributed computing environment, such as a specific application or portion thereof (e.g., a transaction type), a specific logical or physical component, a specific network service, or the like. The display can include performance indicators for that portion of the distributed computer environment (e.g., application, tier, component, service, etc.) being examined by coalescing readings from physical and logical instruments to provide a simple, understandable display. The display can include an optional navigation section to allow the user to more quickly locate the part of the distributed computing environment that the user wants to see. Other information displayed may depend on the particular portion of the distributed computing environment being examined

The displays generated by the user interface can provide information that changes dynamically and in real time or near real time to reflect changes in the distributed computing environment as the distributed computing environment adapts to applications running within it. Therefore, with a single display, users can easily see relevant information regarding a specific application or portion thereof, a specific logical or physical component, or a specific network service in real time or near real time. A user is able to examine or even explore the capabilities of the physical or logical components within the distributed computing environment and to give the user the ability to drill down to whatever level of detail the user desires. The single display can effectively provide an easily understood picture of the dynamic infrastructure used to support an application or a portion thereof (e.g. a transaction type) that is dynamically updated

A few terms are defined or clarified to aid in understanding of the terms as used throughout this specification. The term “application” is intended to mean a collection of transaction types that serve a particular purpose. For example, a web site front store can be an application, human resources can be an application, order fulfillment can be an application, etc.

The term “application infrastructure” is intended to mean any and all hardware, software, and firmware within a distributed computing environment. The hardware can include servers and other computers, data storage and other memories, networks, switches and routers, and the like. The software used may include operating systems and other middleware components (e.g., database software, JAVA™ engines, etc.).

The term “component” is intended to mean a part within an application infrastructure. Components may be hardware, software, firmware, or virtual components. Many levels of abstraction are possible. For example, a server may be a component of a system, a CPU may be a component of the server, a register may be a component of the CPU, etc. For the purposes of this specification, component and resource can be used interchangeably.

The term “de-provisioning” is intended to mean that a physical component is no longer active within an application infrastructure. De-provisioning includes placing a component in an idling, a maintenance, a standby, or a shutdown state or removing the physical component from the application infrastructure.

The term “distributed computing environment” is intended to mean a collection of components comprising at least one application, wherein different types of components reside on different network devices connected to the same network.

The term “instrument” is intended to mean a gauge or control that can monitor or control at least part of an application infrastructure.

The term “logical component” is intended to mean a collection of the same type of components. For example, a logical component may be a web server farm, and the physical components within that web server farm can be individual web servers.

The term “logical instrument” is intended to mean an instrument that provides a reading reflective of readings from a plurality of other instruments. In many, but not all instances, a logical instrument reflects readings from physical instruments. However, a logical instrument may reflect readings from other logical instruments, or any combination of physical and logical instruments. For example, a logical instrument may be an average memory access time for a storage network. The average memory access time may be the average of all physical instruments that monitor memory access times for each memory device (e.g., a memory disk) within the storage network.

The term “physical component” is intended to mean a component that serves a function even if removed from the distributed computing environment. Examples of physical components include hardware, software, and firmware that can be obtained from any one of a variety of commercial sources.

The term “physical instrument” is intended to mean an instrument for monitoring a physical component.

The term “provisioning” is intended to mean that a physical component is in an active state within an application infrastructure. Provisioning includes placing a component in an active state or adding the physical component to the application infrastructure.

The term “transaction type” is intended to mean to a type of task or transaction that an application may perform. For example, information (browse) request and order placement are transactions having different transaction types for a front store application.

As used herein, the terms “comprises,” “comprising,” “includes,” “including,” “has,” “having” and any variations thereof, are intended to cover a nonexclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art in which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, firmware components and acts are conventional and may be found in textbooks and other sources within the computer, information technology, and networking arts.

Before discussing embodiments of the present invention, a non-limiting; exemplary distributed computing environment to aid in the understanding the methods later described in this specification. After reading this specification, skilled artisans will appreciate that many other distributed computing environments can be used in carrying out embodiments described herein and to list every one would be nearly impossible.

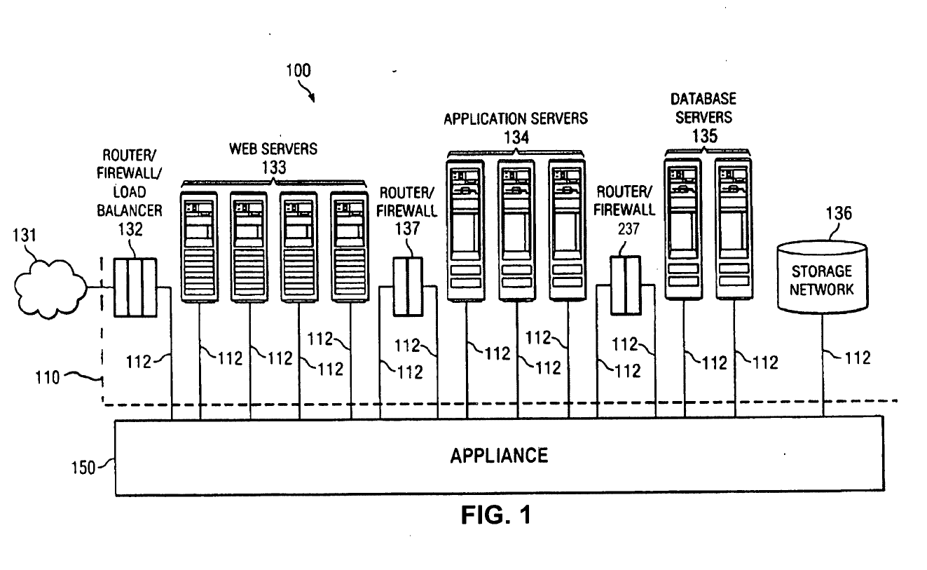

FIG. 1 includes a hardware diagram of a distributed computing environment 100. The distributed computing environment 100 includes an application infrastructure. The application infrastructure includes management blade(s) (not shown in FIG. 1) within an appliance 150 and those components above and to the right of the dashed line 110 in FIG. 1. More specifically, the application infrastructure includes a router/firewall/load balancer 132, which is coupled to the Internet 131 or other network connection. The application infrastructure further includes web servers 133, application servers 134, and database servers 135. Other servers may be part of the application infrastructure but are not illustrated in FIG. 1. Each of the servers may correspond to a separate computer or may correspond to a virtual engine running on one or more computers. Note that a computer may include one or more server engines. The application infrastructure also includes a network 112, a storage network 136 and router/firewalls 137. The management blades within the appliance 150 may be used to route communications (e.g., packets) that are used by applications, and therefore, the management blades are part of the application infrastructure. Although not shown, other additional components may be used in place of or in addition to those components previously described.

Each of the components 132-137 is bi-directionally coupled in parallel to the appliance 150 via network 112. In the case of the router/firewalls 137, the inputs and outputs from such the router/firewalls 137 are connected to the appliance 150. Substantially all the traffic for each of the components 132-137 in the application infrastructure is routed through the appliance 150. Software agents may or may not be present on each of the components 132-137. The software agents can allow the appliance 150 to monitor and control at least a part of any one or more of the components 132-137. Note that in other embodiments, software agents on components may not be required in order for the appliance 150 to monitor and control the components.

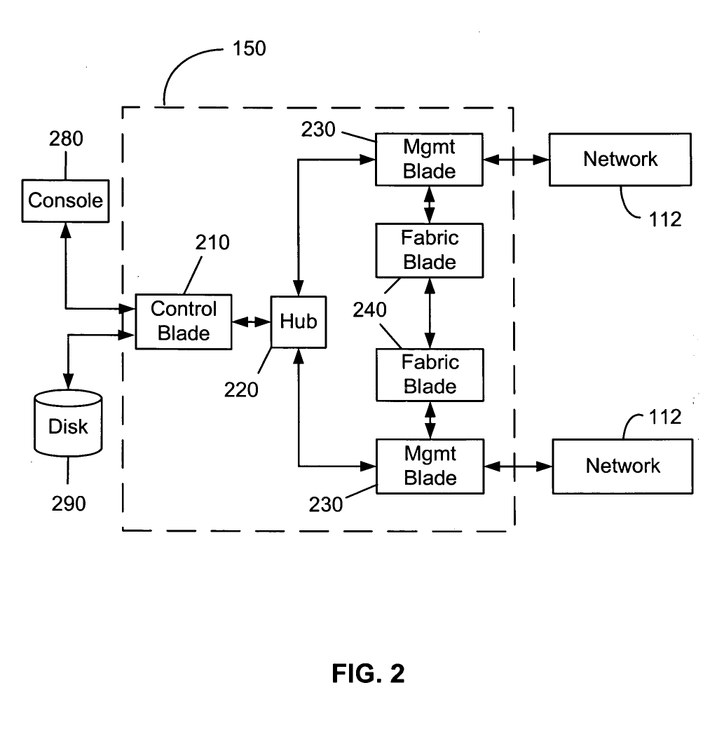

FIG. 2 includes a hardware depiction of the appliance 150 and how it is connected to other components of the distributed computing environment 100. A console 280 and a disk 290 are bi-directionally coupled to a control blade 210 within the appliance 150. The console 280 can allow an operator to communicate with the appliance 150. Disk 290 may include logic and data collected from or used by the control blade 210. The control blade 210 is bi-directionally coupled to a hub 220. The hub 220 is bi-directionally coupled to each management blade 230 within the appliance 150. Each management blade 230 is bi-directionally coupled to the network 112 and fabric blades 240. Two or more of the fabric blades 240 may be bi-directionally coupled to one another.

The management infrastructure can include the appliance 150, network 112, and software agents on the components 132-137. Note that some of the components within the management infrastructure (e.g., the management blades 230, network 112, and software agents on the components 132-137) may be part of both the application and management infrastructures. In one embodiment, the control blade 210 is part of the management infrastructure but not part of the application infrastructure.

Although not shown, other connections and additional memory may be coupled to each of the components within the appliance 150. Further, nearly any number of management blades 230 may be present. For example, the appliance 150 may include one or four management blades 230. When two or more management blades 230 are present, they may be connected to different parts of the application infrastructure. Similarly, any number of fabric blades 240 may be present. In still another embodiment, the control blade 210 and hub 220 may be located outside the appliance 150, and in yet another embodiment, nearly any number of appliances 150 may be bi-directionally coupled to the hub 220 and under the control of the control blade 210.

The control blade 210, the management blades 230, or both may include a central processing unit (“CPU”) or controller. Therefore, the appliance 150 is an example of a data processing system. Although not shown, other connections and memories (not shown) may reside in or be coupled to any of the control blade 210, the management blade(s) 230, or any combination thereof. Such memories can include, content addressable memory, static random access memory, cache, first-in-first-out (“FIFO”), other memories, or any combination thereof. The memories, including disk 290 can include media that can be read by a controller, CPU, or both. Therefore, each of those types of memories includes a data processing system readable medium.

Portions of the methods described herein may be implemented in suitable software code that include for carrying out the methods. In one embodiment, the instructions may be lines of assembly code or compiled C⁺⁺, Java, or other language code. Part or all of the code may be executed by one or more processors or controllers within the appliance 150 (e.g., on the control blade 210, one or more of the management blades 130, or any combination thereof) or on one or more software agent(s) (not shown) within components 132-137, or any combination of the appliance 150 or software agents. In another embodiment, the code may be contained on a data storage device, such as a hard disk (e.g., disk 290), magnetic tape, floppy diskette, CD ROM, optical storage device, storage network (e.g., storage network 136), storage device(s), or other appropriate data processing system readable medium or storage device.

Other architectures may be used. For example, the functions of the appliance 150 may be performed at least in part by another apparatus substantially identical to appliance 150 or by a computer (e.g., console 280), such as any one or more illustrated in FIG. 1. Additionally, a computer program or its software components with such code may be embodied in more than one data processing system readable medium in more than one computer. Note the appliance 150 is not required, and its functions can be incorporated into different parts of the distributed computing environment 100 as illustrated in FIGS. 1 and 2.

Attention is now directed to methods of creating and using a user interface. A challenge for designing the user interface is to provide a simple, easily understood overview of a distributed computing environment or any portion of it. The overview can be an object-oriented metaphor that can include instruments, such as logical or physical gauges and controls, and other information that is similar to dashboard of an automobile.

The design considerations are not difficult to understand but can be very challenging to implement. Providing useful information to a user in such an overview without providing too little or too much information to the user is a difficult task. Navigating between any two displays using the interface should be as simple and intuitive as possible. Users should also have the ability to drill down whatever level of detail for data regarding the status and operation of the distributed computing environment or any portion of it. As will be described in more detail with screen shots of displays later in this specification, some items, such as performance indicators, may be present on any or all displays, and other items, such as resources used by an application, will only appear on a specific type of display (e.g. a display for an application running within the distributed computing environment).

The user interface can also allow for input for the desires of any specific user to generate any one or more customized displays, which are referred to in this specification as personal views. A user can start from a default display and modify from it or create a personal view from scratch.

In one embodiment, the user interface is a browser-based graphical user interface (“GUI”) to allow for ease of use without having to provide extensive training to users on the operation of the user interface. Most users are familiar with browser-based GUIs, and their use (e.g., use of pull-down menus, clicking on icons, etc.) is reasonably intuitive and requires little, if any, training. In other embodiments, other types of user interfaces can be implemented. The user interface can be used to generate displays on the console 280 or other computer. The code for the user interface may reside within the disk 290, the appliance 150 (e.g., on the control blade 210), the console 280, or another computer (not shown). Data used to generate the displays may come from the disk 290 (e.g., templates for default or personal views, preferences, display configuration information, etc.), the appliance 150 (e.g., readings from physical or logical instruments on the management blades 250), software agents on managed components 132-137 (e.g., readings from physical or logical instruments on physical or logical components connected to network 112), or any combination thereof.

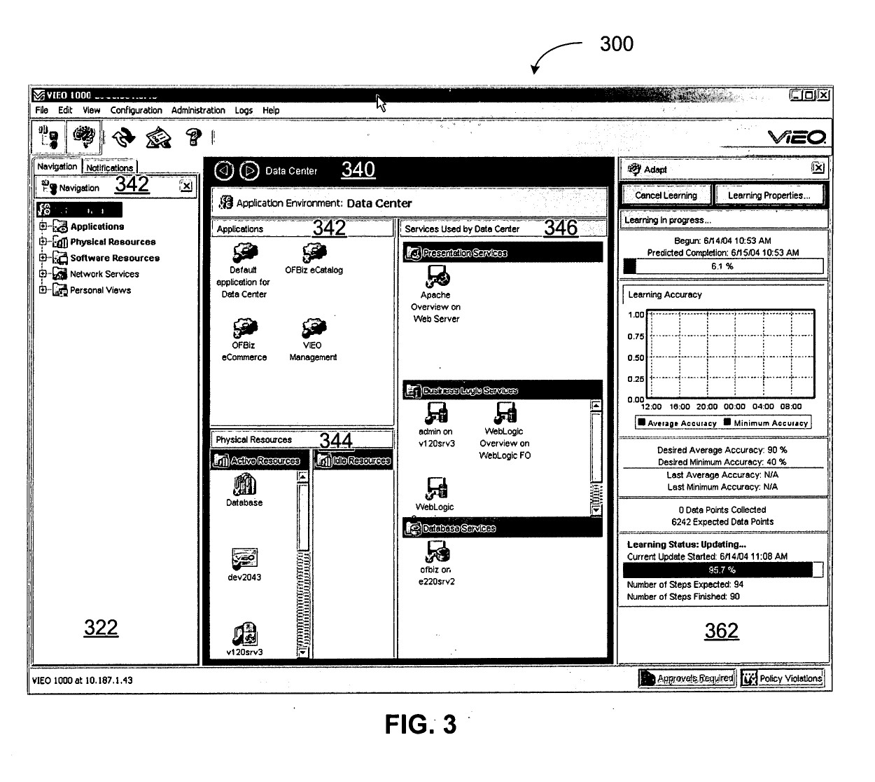

User interface design considerations and use of the user interface is described with respect to screen shots for displays in FIGS. 3, 4, and 6-13. Various aspects of the user interface will be described with respect to the first display having each of the aspects. Throughout the displays, many items, such as applications, resources, and services, are illustrated as representations. Each of the representations can include text, an icon, other metaphor, or any combination thereof. While the screen shots include specific information, after reading this specification, skilled artisans will understand that many different embodiments are possible. Therefore, the screen shots are to be construed as illustrative and do not limit the present invention.

FIG. 3 includes a display 300 for a distributed computing environment, such as a data center. The display 300 includes a navigation section 322, a main section 340, and a right-hand section 362. The navigation section 322 allows a user to quickly navigate through portions of the data center to obtain information that the user desires. Referring to navigation section 322, items with in the data center include applications, physical resources, software resources, network services, and personal views. A user can expand any of the entries and drill down to the level of information the user desires. The navigation section 322 can always be displayed. In another embodiment, the navigation section 322 is optional, and a user can close the navigation section 322 if the user desires.

For the display 300, the main section 340 includes information similar to the navigation section 322. Portions within the main section 340 include applications 342, physical resources 344, and services used by the data center 346. “Applications” 342 include “Default application for Data Center,” “OFBiz e-Commerce,” “OFBiz eCatalog,” and “VIEO Management.” Note that this same information could also be obtained by expanding “Applications” within the navigation section 322.

The physical resources 344 can include “Active Resources,” such as “Database,” “dev2043,” and “v120srv3.” Although none are illustrated in FIG. 3, idle resources may also be displayed within the physical resources 344. The services used by the data center 346 can include presentation services, business logic services, and database services. As illustrated in the display 300, presentation services can include “Apache Overview on Web Server,” business logic services can include “admin on v120srv3,” “WebLogic Overview on WebLogic FO,” and database services can include “ofbiz on e220srv2.”

The left-hand section 362 includes icons for a user to cancel learning and to display learning properties. The left-hand section 362 also includes information regarding a learning sequence that is currently in progress. Information can include when the learning sequence began, predicted completion time, and percentage of completion done (illustrated using a graphical indicator). Other information within the left-hand section 362 can include learning accuracy as displayed using charts and other statistics related to accuracy. The left-hand section 362 can also include the number of data points collected and the number of expected data points. The left-hand section 362 can include a learning status that may be updated and include statistics and a graphical indicator related to number of steps used for updating.

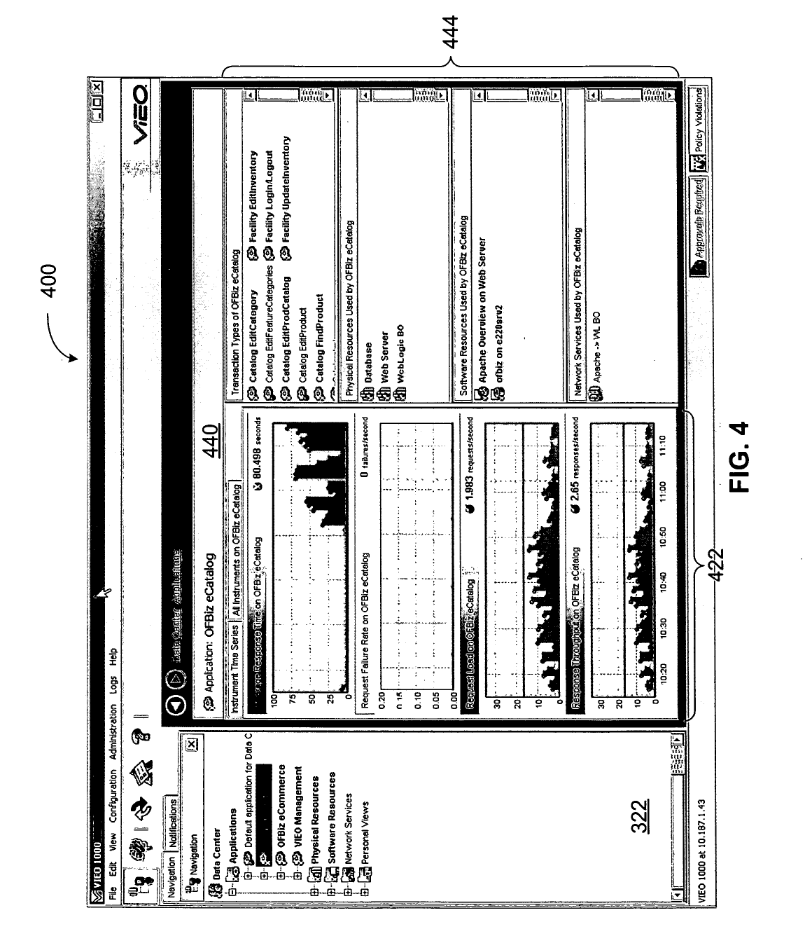

FIG. 4 illustrates a display 400 that includes information from one of the applications running within the distributed computing environment. Referring to the navigation section 322, “Applications” has been expanded, and “OFBiz eCatalog” has been selected. Therefore, the display 400 includes information regarding “OFBiz eCatalog” within the main section 440.

Performance indicators of the application appear in the left-hand portion 442 of the main section 440. Performance indicators will be shown for nearly any part of the data center, including physical resources, software resources, network services, and the like. The actual performance indicators typically depend on the part of the distributed computing environment being examined. In one embodiment, performance indicators for an application include average response time, request failure rate, request load, and response throughput. In another embodiment, more, fewer, or different performance indicators may be used. In yet another embodiment, different applications could have different performance indicators. The performance indicators may be coded into the user interface (i.e., user cannot change selection of the performance indicators) or may allow input from the user to change the performance indicators for any or all applications displayed using the user interface. The actual performance indictor selected to be displayed should be the more important logical or physical gauges for the application and the number should not be so high as to make observations of the performance indicators difficult or too time consuming to understand.

A user can examine all instruments on “OFBiz eCatalog” by selecting the tab near the top of the left-hand portion 442. Such information allows a user to investigate specific instruments (e.g., controls, gauges, or both at a physical or logical level) to allow the user to drill down to whatever level of information that the user desires. In one embodiment, the user can drill down to a specific physical instrument for a specific physical component.

The right-hand portion 444 within the main section 440 includes transaction types and physical and logical components (e.g., physical resources, software resources, network services, etc.) used by “OFBiz eCatalog.” Some exemplary transaction types can include “Catalog EditCategory,” “Catalog EditFeatureCategories,” “Catalog EditProductCatalog,” “Catalog EditProduct,” “Catalog FindProduct,” “Facility EditInventory,” “Facility Login/Logout,” and “Facility UpdateInventory.” Note that this list of transaction types is not meant to be limiting and in other embodiments more, fewer, or different transaction types may be present. The list of transaction types may include only those transaction types actually used by the application up to that point in time or all transactions that can be used by the application. The display 400 may use different fonts to illustrate transaction types actually used or in use by the application compared to transactions types for the application that have not actually be used or are not currently in use.

Some exemplary physical resources used by “OFBiz eCatalog” can include “Database,” “Web Server,” and “WebLogic BO.” Some exemplary software resources used by “OFBiz eCatalog” can include “Apache Overview on Web Server” and “ofbiz on e220srv2.” A network service used by “OFBiz eCatalog” can include “Apache->WL BO.” Note that these examples are merely to illustrate and are not meant to limit the present invention. After reading this specification skilled artisans will understand what information that the organization or individuals within the organization desire to see when displaying information regarding any one or more applications.

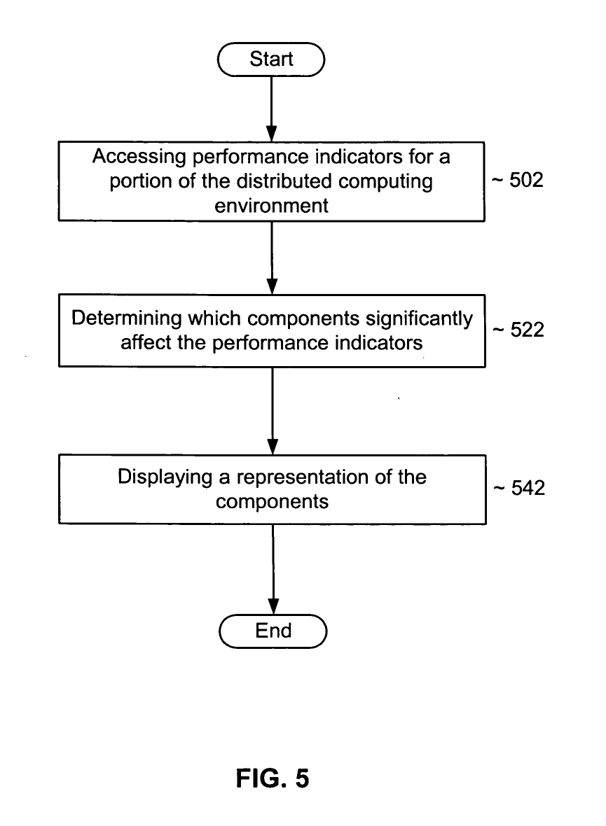

FIG. 5 includes a process flow diagram that illustrates one method the user interface can use in generating the display 400. The method will be described more generically than its use for generating the display 400 because portions may be applicable to displays of other portions of the distributed computing environment. The method can include accessing performance indicators for a portion of the distributed computing environment (block 502 in FIG. 2). The selection of performance indicators was previously described. In one embodiment, the list of performance indicators may be within a memory within the appliance 150, console 280, the disk 290, or other storage location. The user interface will display the physical or logical gauges that correspond to performance indicators for the application being displayed. For other applications running within the distributed computing environment or other portions of the distributed computing environment (e.g., physical resources, software resources, network services, etc.), the methodology is substantially identical.

The method can also include determining which components significantly affect the performance indicators (block 522). A correlation engine can use regression or other similar method to make the determination. Such a correlation engine and methodology for using may be of any of the one described in U.S. patent application Ser. No. 10/755,790 entitled “Methods and Systems for Estimating Usage of Components for Different Transaction Types” by Bishop et al. filed on Jan. 12, 2004. or U.S. patent application No. ______ entitled “Methods of Determining Usage of Components By Different Transaction Types and Data Processing System Readable Media for Carrying Out the Methods” by Bishop et al. filed on ______ (Docket No. VIEO1300). A user may be able to adjust the confidence level used within the correlation engine to control what is or is not considered significant. Each of the components can be segregated into which type of component it is, such as a physical resource, software resource, network service, or the like. The data that may be used by the correlation engine may be generated using the distributed computing environment 100 during its normal mode (running applications) or during a learning mode.

Each of the performance indicators may be associated with any number and different components. For example, referring only to physical resources, “Average Response Time on OFBiz eCatalog” may be significantly affected by “Database,” “Web Server,” and “WebLogic FO;” and “Request Fault Rate on OFBiz eCatalog may be significantly affected by “WebServer” and “WebLogic FO,” and not “Database.” Only a union of the components may be displayed. Therefore, the union for this specific example includes “Database,” “Web Server,” and “WebLogic FO.” Two icons each for “WebServer” and “WebLogic FO” are not needed. Similar methodologies can be used to create a union of components that significantly affect other performance indicators.

The method can include displaying a representation of the components (block 542). Referring to FIG. 4, the representations of the components are illustrated as icons and text within the physical resources, software resources, and network services within the left-hand section 442 of the display 400.

The method can be implemented so the user interface provides information to the user via the display 400 in real time or near real time as the distributed computing environment dynamically changes. The term “real time” is intended to mean occurring substantially immediately, such that from the distributed computing environment's perspective, an inconsequential period of time has lapsed between any two events. The term “near real time” is intended to mean occurring at a time slightly after a prior event. Real time and near real time may in part depend on the specific computing environment and the CPU rate. Although not meant to be limiting, near real time is typically no more than minute and can be no less than a second.

At a first time, a first set of data can be collected from instruments within the distributed computing environment. For the application and its performance indicators, a first set of components may be determined to significantly affect the performance indicators for the application at the first time. At a second time, which may or may not partially overlap with the first time, a second set of data can be collected from instruments within the distributed computing environment. For the application and its performance indicators, a second set of components may be determined to significantly affect the performance indicators for the application at the second time. When comparing the first set of components to the second set of components, the second set may have the same, more, fewer, or different components compared to the first set because the distributed computing environment is dynamic and can change at a relatively high frequency. The user interface can be used to automatically reflect the changes in the distributed computing environment.

In one embodiment, servers may be provisioned or deprovisioned as the application runs within the distributed computing environment. As the servers are provisioned or deprovisioned, the display 400 can be updated in real time or near real time to reflect current conditions within the distributed computing environment. For example, if the database server 135 is deprovisioned and an application server 134 is provisioned and used by the application, the database server 135 (as shown in the display 400) will be removed from the physical resources, and the application server (representation not shown in the display 400) will be added to the physical resources. Similar actions would be seen for software resources and network services within the left-hand section 442 of the display 400.

Transaction types are similar to applications with respect to performance indicators and components. In one embodiment, not shown, a display for a transaction type may be substantially the same as the one used for applications (e.g., display 400) except that transaction types (as seen in the left-hand section) would not be displayed.

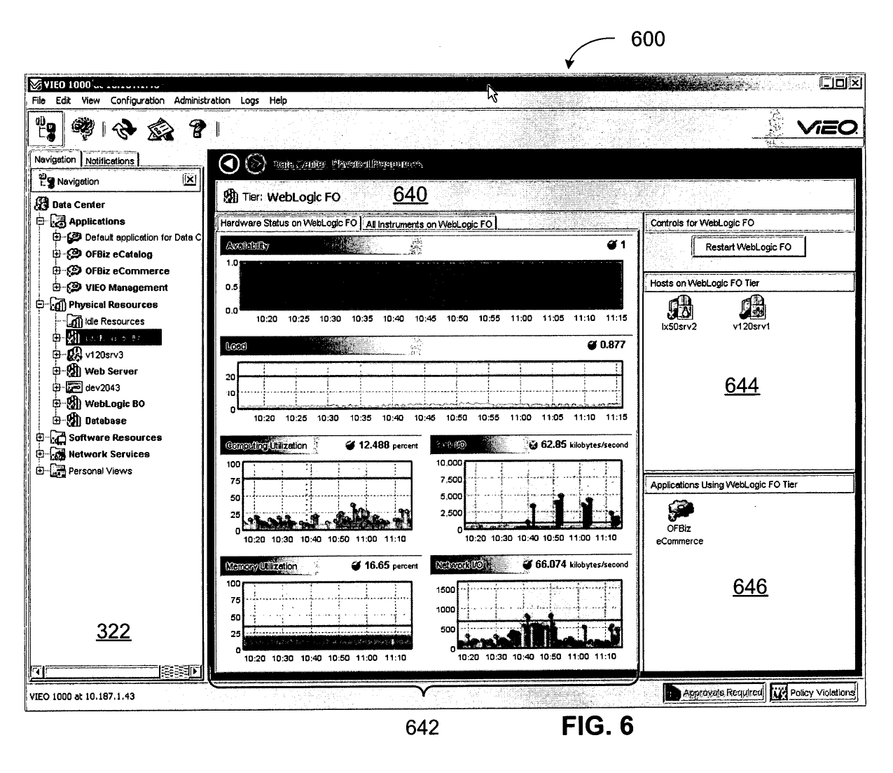

FIG. 6 illustrates a display 600 that includes a view of information regarding one of the physical resources. Referring to navigation section 522, physical resources has been expanded and “WebLogic FO” has been selected. Information regarding “WebLogic FO” is displayed within the main section 640. The main section 640 includes portions 642, 644, and 646. Portion 642 includes performance indicators for “WebLogic FO,” such as availability, load, computing utilization, disk input/output rate (“I/O”), memory utilization, and network I/O. Similar to the display 400, a user can select to see all instruments that are on “WebLogic FO” by selecting the tab near the top of portion 642. Portion 642 includes “Hosts on WebLogic FO Tier.” In this specific embodiment, the hosts include “1x50srv2” and “v120srv1.” Portion 646 includes “Applications Using WebLogic FO Tier,” which in the display 600 includes “OFBiz eCommerce.”

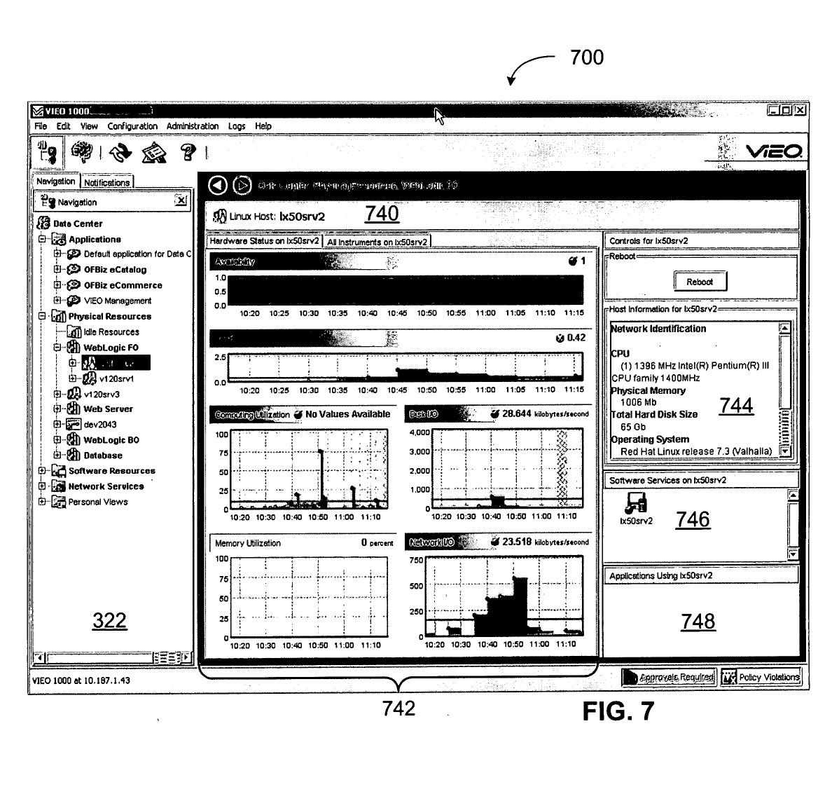

FIG. 7 illustrates a display 700 that includes information regarding one of the servers within the WebLogic FO tier. Referring to navigation section 522, “WebLogic FO” has been expanded and “1x50srv2” (a server within WebLogic FO) has been selected. Information regarding “1x50srv2” is displayed within the main section 740. The main section 740 includes portions 742, 744, 746, and 748. Portion 742 includes performance indicators for “1x50srv2.” The performance indicators include availability, load, computing utilization, disk I/O, memory utilization, and network I/O. Portion 744 includes specification information, such as network identification, CPU, physical memory, total hard disk size, and operating system information. Portion 746 includes “Software Services on 1x50srv2,” and portion 748 includes “Applications Using 1x50srv2.” The display 700 includes an icon that allows the user to reboot 1x50srv2 from the display panel (e.g., at console 280).

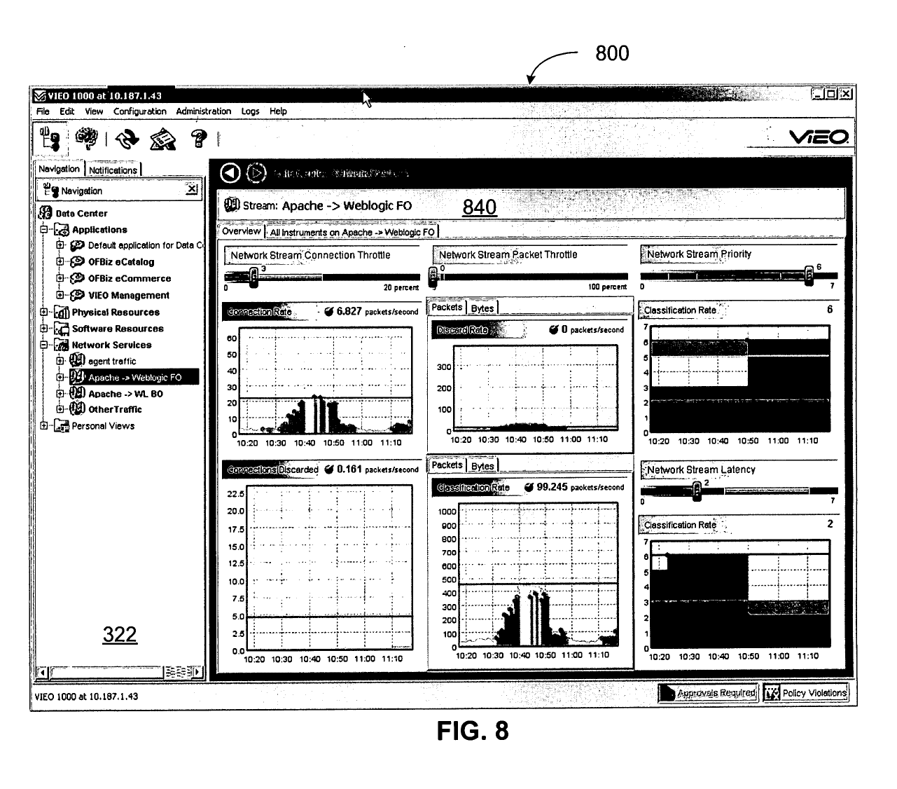

FIG. 8 illustrates display 800 that includes information regarding one of the network services. Referring to the navigation section 522, network services has been expanded and “Apache->WebLogic FO” has been selected. Information regarding “Apache->WebLogic FO” is displayed within the main section 840. The main section 842 includes controls and gauges. The controls include network stream connection throttle, network stream packet throttle, network stream priority, and network stream latency. The controls are illustrated with graphic indicators and bar-shaped icons. The bar-shaped icons within the controls are used to adjust the settings on the controls by allowing a user to click-and-drag the bar-shaped icons. Minimum, maximum, and current settings are displayed with each of the controls. Gauges within main section 840 include network stream connection rate, network stream connections discarded, network stream packet discard rate, network stream packet classification rate, network stream priority classification rate, and network stream latency classification rate.

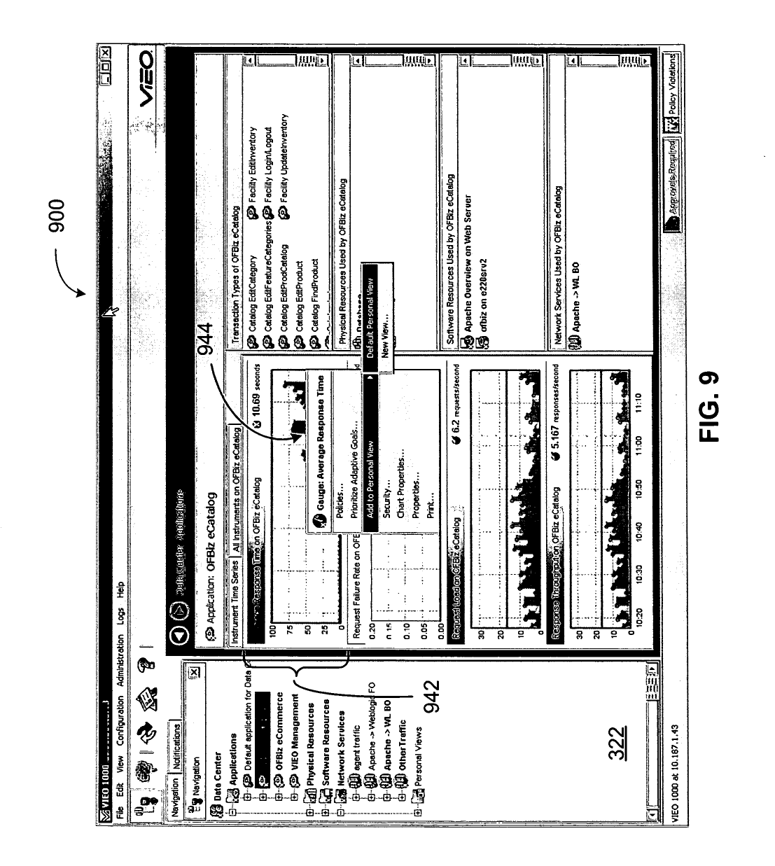

The user interface has great flexibility and can create one or more personal views to allow the user to see what the user desires. Nearly any collection of information described with respect to the displays 400 and 600-800 may be assembled into a personal view. FIGS. 9-13 illustrate processes for editing personal views.

FIG. 9 includes a display 900 that illustrates how an instrument can be added to a personal view. The display 900 is similar to the display 400 previously described. Within main section 940, “Average Response Time on OFBiz eCatalog” 942 is to be added to a personal view. A user right-clicks over the gauge, at which point, pull-down menu 944 appears. “Add to Personal View” and “Default Personal View” are selected. “Average Response Time on OFBiz eCatalog” 942 is now one of the instruments that will be displayed within the default personal view.

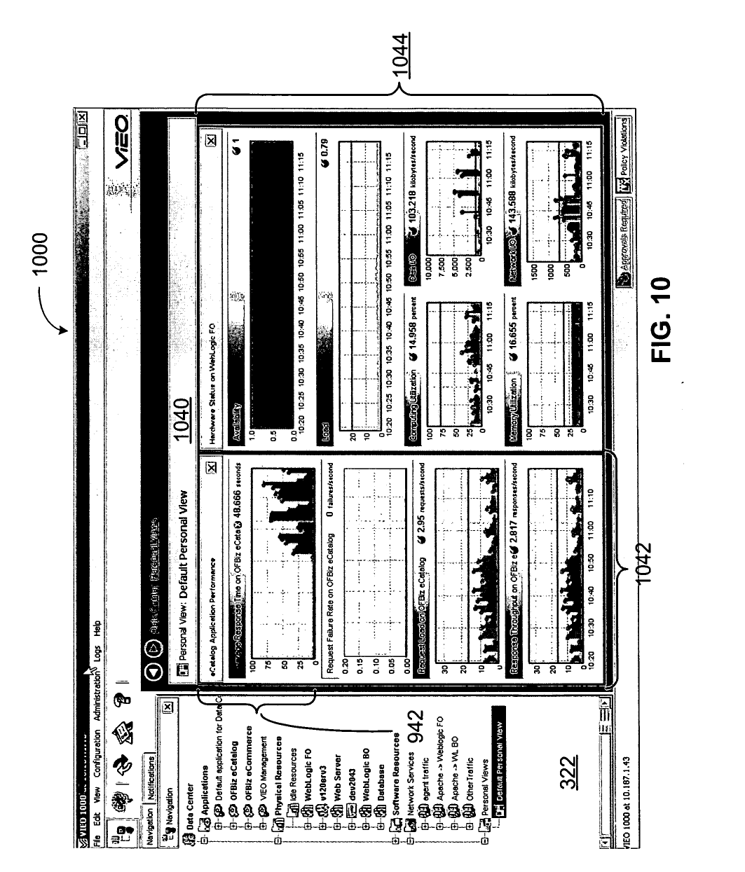

FIG. 10 includes a display 1000 that illustrates the default personal view. The default personal view can be selected by expanding “Personal Views” and selecting “Default Personal View” within the navigation section 522. As illustrated in FIG. 10, the main section 1040 of the display includes a left-hand portion 1042, which is the same as the left-hand portion 442 of the display 400, and a right-hand portion 1044, which is the same as the left-hand portion 642 of the display 600. “Average Response Time on OFBiz eCatalog” 942, which was added from the display 900, can be seen in the left-hand portion 1042 of the main section 1040 in the display 1000.

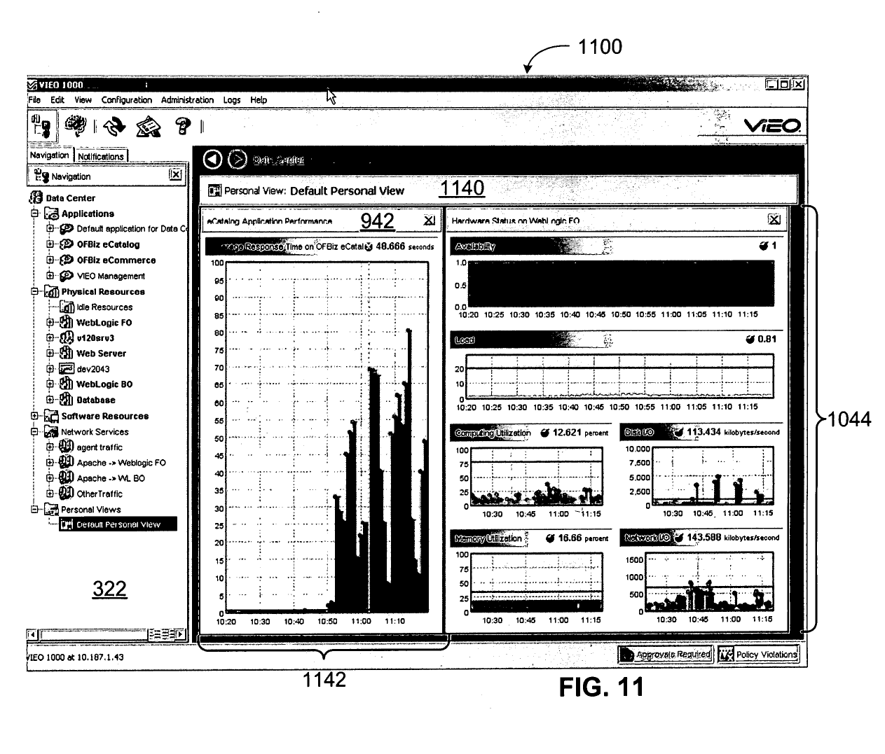

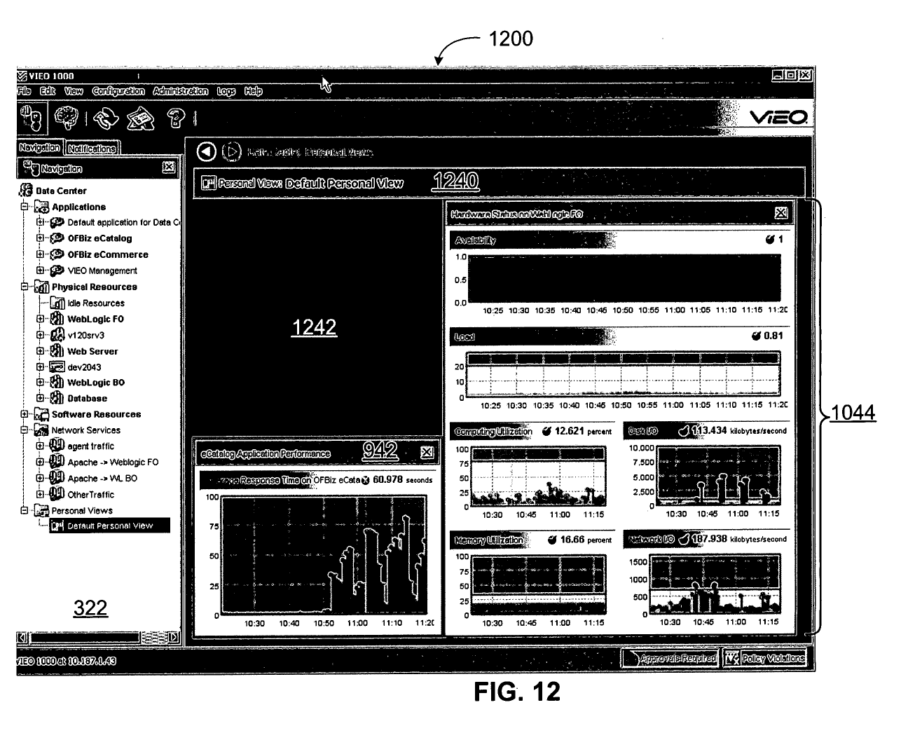

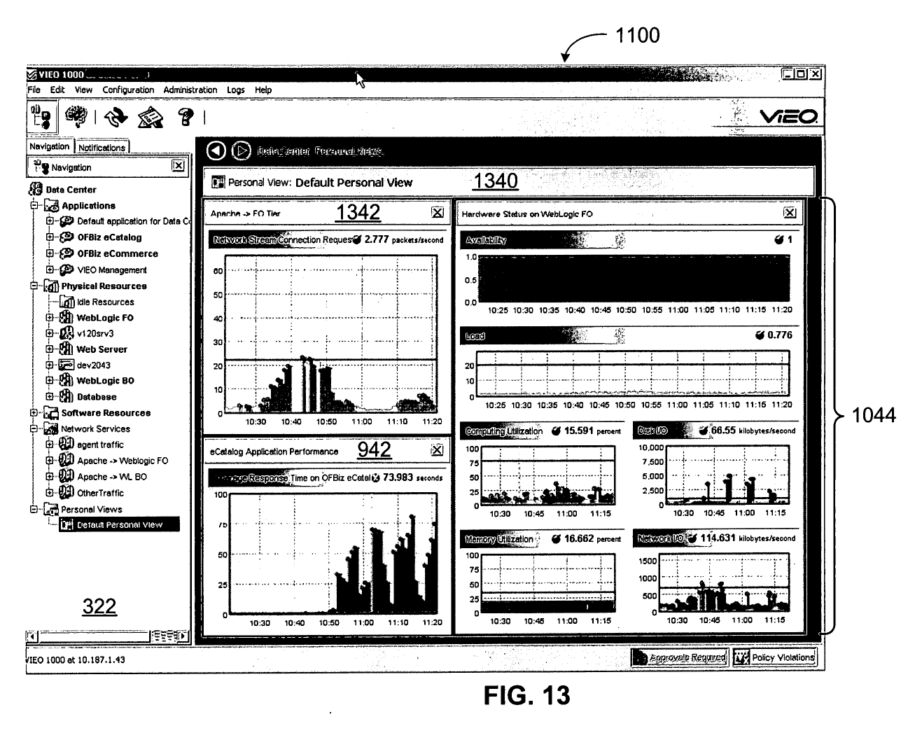

FIGS. 11-13 includes displays 1100, 1200, and 1300 that illustrates that a personal view can be manipulated as a user desires. Referring to FIG. 11, the display 1100 includes a main section 1140 includes a left-hand portion 1142 where “Average Response Time on OFBiz eCatalog” 942 has been enlarged. The other gauges illustrated within the left-hand portion 1042 of display 1000 (FIG. 10) still exist but are not currently part of the display 1100. Referring to FIG. 12, “Average Response Time on OFBiz eCatalog” 942 within the main section 1240 of the display 1200 has been reduced (compared to the display 1100) to allow open space 1242 to be created within the main section 1240 that will allow another instrument to be added to the default personal view. In this embodiment, “Network Stream Connection Request Rate” 1342 (from “Apache->WebLogic OF” network service, see the main section 840 of the display 800 in FIG. 8) is being added. Referring to FIG. 13, the “Network Stream Connection Request Rate” 1342 is added within the main section 1340 of the display 1300 where open space 1242 (FIG. 12) previously existed. In this particular default personal view, information from instruments on the application (“OFBiz eCatalog”), physical resources (“WebLogic FO”), and network service (“Apache->WL FO”) are part of a single display. The default personal view may be edited in many other ways, and other personal views may be created to better meet the needs or desires of the user.

The embodiments user interface as described herein has many benefits. The user interface can generate a “dashboard” of displays, wherein each display effectively presents an overview of a portion of a distributed computing environment. The displays generated by the user interface can provide information that changes dynamically and in real time or near real time to reflect changes in the distributed computing environment as the distributed computing environment adapts to applications running within it. A user is able to examine or even explore the capabilities of the physical or logical components within the distributed computing environment and to give the user the ability to drill down to whatever level of detail the user desires. The single display can effectively provide an easily understood picture of the dynamic infrastructure used to support an application or a portion thereof (e.g. a transaction type) that is dynamically updated.

Many of the displays in FIGS. 3, 4, and 6-13 include many details and examples of items that may or may not appear within each of the displays or portions thereof. Therefore, the details and examples within each of the displays are to be construed as illustrating some embodiments and not to limit the present invention. After reading this specification, skilled artisans will appreciate that many other embodiments are possible to list every conceivable embodiment would be nearly impossible.

Note that not all of the activities described above in the general description or the example are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. A method of using a user interface for a distributed computing environment comprising:
accessing a first performance indicator for at least a portion of the distributed computing environment;
determining which components within the distributed computing environment significantly affect the first performance indicator by using a first set of data collected from instruments within the distributed computing environment to form a first set of components; and
displaying a representation of the first set of components.

2. The method of claim 1, wherein:
the method further comprises:
accessing a second performance indicator for the at least a portion of the distributed computing environment; and
determining which components within the distributed computing environment significantly affect the second performance indicator using the first set of data collected from instruments within the distributed computing environment to form a second set of components; and
displaying comprises displaying a union of representations of the first and second sets of components.

3. The method of claim 1, further comprising:
determining which components within the distributed computing environment significantly affect the first performance indicator by using a second set of data collected from instruments within the distributed computing environment to form a second set of components, wherein:
the second set of data is collected during a different time period compared to the first set of data; and
the second set of components is different from the first set of components; and
displaying a representation of a second set of components, wherein any component that belongs to the first set of components but not the second set of components is not displayed during displaying a representation of the second set of components.

4. The method of claim 1, wherein determining and displaying are performed automatically to reflect changes within the distributed computing environment.

5. The method of claim 1, further comprising collecting the first set of data while the distributed computing environment is in its normal operating mode.

6. The method of claim 1, further comprising collecting the first set of data while the distributed computing environment is in a learning mode.

7. The method of claim 1, further comprising displaying the first performance indicator.

8. The method of claim 1, further comprising displaying a navigation bar.

9. An appliance for carrying out the method of claim 1.

10. A method of using a user interface for a distributed computing environment comprising:
at a first time,
displaying a first performance indicator for at least a portion of the distributed computing environment; and
displaying one or any combination of:
a representation of a first set of components within the distributed computing environment, wherein the first set of components significantly affect the first performance indicator;
a first control that significantly affects the first performance indicator;
a representation of a component that lies within or uses the at least a portion of the distributed computing environment; or
an application that uses the at least a portion of the distributed computing environment.

11. The method of claim 10, further comprising:
at the first time, displaying one or any combination comprises displaying the representation of the first set of components within the distributed computing environment; and
at a second time,
displaying the first performance indicator; and
displaying a representation of a second set of components within the distributed computing environment, wherein the second set of components significantly affect the first performance indicator.

12. The method of claim 11, further comprising, at the first and second times, displaying a navigation bar.

13. The method of claim 10, wherein:
the at least a portion of a distributed computing environment is an application;
displaying the first performance indicator comprises displaying performance indicators for the application; and
displaying one or any combination comprises:
displaying representations of transaction types of the application; and
displaying one or any combination comprises displaying a representation of the first set of components within the distributed computing environment.

14. The method of claim 10, wherein:
the at least a portion of a distributed computing environment is a tier of components;
displaying the first performance indicator comprises displaying performance indicators for the tier of components, wherein the performance indicators includes the first performance indicator; and
displaying one or any combination comprises:
displaying a representation of provisioned components within the tier; and
displaying a representation of an application using the tier.

15. The method of claim 10, wherein:
the at least a portion of a distributed computing environment is a physical component;
displaying the first performance indicator comprises displaying performance indicators for the physical component, wherein the performance indicators includes the first performance indicator; and
displaying one or any combination comprises:
displaying specification information regarding the physical component;
displaying a representation of a software service on or using the physical component; and
displaying a representation of an application using the physical component.

16. The method of claim 10, wherein:
the at least a portion of a distributed computing environment is a network service;
displaying the first performance indicator comprises displaying performance indicators for the network service, wherein the performance indicators includes the first performance indicator; and
displaying the one or any combination comprises displaying controls that significantly affect the performance indicators, wherein the controls include the first control.

17. A data processing system readable medium having code for a user interface for a distributed computing environment, wherein the code is embodied within the data processing system readable medium, the code comprising:
an instruction for accessing a first performance indicator for at least a portion of the distributed computing environment;
an instruction for determining which components within the distributed computing environment significantly affect the first performance indicator by using a first set of data collected from instruments within the distributed computing environment to form a first set of components; and
an instruction for displaying a representation of the first set of components.

18. The data processing system readable medium of claim 17, wherein:
the code further comprises:
an instruction for accessing a second performance indicator for the at least a portion of the distributed computing environment; and
an instruction for determining which components within the distributed computing environment significantly affect the second performance indicator using the first set of data collected from instruments within the distributed computing environment to form a second set of components; and
the instruction for displaying comprises an instruction for displaying a union of representations of the first and second sets of components.

19. The data processing system readable medium of claim 17, wherein the code further comprises an instruction for repeating the instructions for determining and displaying such that:
the instruction for determining uses a second set of data collected from instruments within the distributed computing environment to form a second set of components, wherein:
the second set of data is collected during a different time period compared to the first set of data; and
the second set of components is different from the first set of components; and
the instruction for displaying comprises an instruction for displaying a representation of a second set of components, wherein any component that belongs to the first set of components but not the second set of components is not displayed during displaying the representation of the second set of components.

20. The data processing system readable medium of claim 17, wherein the instructions for determining and displaying are executed automatically to reflect changes within the distributed computing environment.

21. The data processing system readable medium of claim 17, wherein the code further comprises an instruction for collecting the first set of data while the distributed computing environment is in its normal operating mode.

22. The data processing system readable medium of claim 17, wherein the code further comprises an instruction for collecting the first set of data while the distributed computing environment is in a learning mode.

23. The data processing system readable medium of claim 17, wherein the code further comprises an instruction for displaying the first performance indicator.

24. The data processing system readable medium of claim 17, wherein the code further comprises an instruction for displaying a navigation bar.

25. An appliance comprising the data processing system readable medium of claim 17.

26. A data processing system readable medium having code for a user interface for a distributed computing environment, wherein the code is embodied within the data processing system readable medium, the code comprising:
an instruction for displaying a first performance indicator for at least a portion of the distributed computing environment; and
an instruction for displaying one or any combination of:
a representation of a first set of components within the distributed computing environment, wherein the first set of components significantly affect the first performance indicator;
a first control that significantly affects the first performance indicator;
a representation of a component that lies within or uses the at least a portion of the distributed computing environment; or
an application that uses the at least a portion of the distributed computing environment.

27. The data processing system readable medium of claim 26, wherein the code further comprises an instruction for displaying a navigation bar.

28. The data processing system readable medium of claim 26, wherein:
the at least a portion of a distributed computing environment is an application;
the instruction for displaying the first performance indicator comprises an instruction for displaying performance indicators for the application, wherein the performance indicators includes the first performance indicator; and
the instruction for displaying one or any combination comprises:
an instruction for displaying representations of transaction types of the application; and
an instruction for displaying one or any combination comprises displaying the representation of the first set of components within the distributed computing environment.

29. The data processing system readable medium of claim 26, wherein:
the at least a portion of a distributed computing environment is a tier of components;
the instruction for displaying the first performance indicator comprises an instruction for displaying performance indicators for the tier of components, wherein the performance indicators includes the first performance indicator; and
the instruction for displaying one or any combination comprises:
an instruction for displaying a representation of provisioned components within the tier; and
an instruction for displaying a representation of an application using the tier.

30. The data processing system readable medium of claim 26, wherein:
the at least a portion of a distributed computing environment is a physical component:
the instruction for displaying the first performance indicator comprises an instruction for displaying performance indicators for the physical component, wherein the performance indicators includes the first performance indicator; and
the instruction for displaying one or any combination comprises:
an instruction for displaying specification information regarding the physical component;
an instruction for displaying a representation of a software service on or using the physical component; and
an instruction for displaying a representation of an application using the physical component.

31. The data processing system readable medium of claim 26, wherein:
the at least a portion of a distributed computing environment is a network service;
the instruction for displaying the first performance indicator comprises an instruction for displaying performance indicators for the network service, wherein the performance indicators includes the first performance indicator; and
the instruction for displaying the one or any combination comprises an instruction for displaying controls that significantly affect the performance indicators, wherein the controls includes the first control.
